(19) United States
(12) Patent Application Publication
(10) Pub. No.: US 2001/0049668 A1
(43) Pub. Date: Dec. 6, 2001

(54) Integrated marketplace model

(76) Inventor: Dolores M. Wright, Rochester, MN (US)

Correspondence Address: LAW OFFICES OF MICHAEL DRYJA, 704 228TH AVENUE NE, PMB 694, SAMMAMISH, WA, 98074, US

(21) Appl. No.: 09/681,786

(22) Filed: Jun. 5, 2001

Related U.S. Application Data
(60) Provisional application No. 60/209,189, filed on Jun. 5, 2000.

(51) Int. Cl. G06G 1/14; G06F 17/60; G06G 7/00; G06F 17/00

(52) U.S. Cl. 705/400; 705/26; 705/37; 705/28; 705/22

(57) ABSTRACT

What is disclosed is The Integrated Marketplace Model is a business model that applies to a marketplace viewed as consisting of several markets, each of which supplies and/or is supplied by another. It covers both the timing of supplies by one market to another and to the end-user and the prices charged for supplies by one market to another.

### CROSS REFERENCE TO RELATED APPLICATIONS

This application claims priority to and the benefit of the previously filed provisional application filed on Jun. 5, 2000, and assigned Ser. No. 60/209,189.

### BACKGROUND OF INVENTION

Definitions:

A marketplace for product X may contain three markets: the originator market, the wholesale market, and the retail market or it may contain these three markets plus any number of wholesale markets, each at a different level in the value chain. In the originator market, the manufacturer, grower, or miner supplies the wholesaler with X. In the wholesale market, the wholesaler supplies the retailer or another wholesaler with X. In the retail market the retailer supplies the end-user with X. A marketplace for product X may also contain two markets; in this case the originator supplies the retailer with X and the retailer supplies the end-user with X. A marketplace for product X can contain one market; in this case the originator supplies the end-user with X, e.g. the manufacturer of auto-parts supplies them direct to the auto-maker. Throughout this document explanations are given in terms of a marketplace containing three markets for product X (originator market, wholesale market, and retail market), but the document should be understood as also applying mutatis mutandis to a marketplace containing more than one wholesale market for product X, to a marketplace containing two markets for product X, and to a marketplace containing one market for product X.

An order: if a company needs X, then a buyer, acting on behalf of the company, places an order for a specified quantity of product X with a supplier of X; he will then receive X.

A fairprice for X is one that is based on some objective principle selected and agreed between the buyer and the seller.

The reserve inventory is the amount of stock that a supplier wishes to hold in reserve.

Delivery period is the period between a confirmed delivery coming into existence and the delivery of the goods listed in the confirmed delivery.

Risky business. Currently wholesalers buy a consignment of X from the originators and retailers buy a consignment of X from the wholesalers before the current value of this consignment of X to the end-user has been established by their purchase of X.

This means that sometimes the price that the wholesaler agrees to pay the originator when he places an order with him turns out to be too high given, (a) the price the retailer is willing to pay the wholesaler and, (b) the wholesaler's target profit margin.

Similarly sometimes the price that the retailer agrees to pay the wholesaler when he places an order with him turns out to be too high given, (a) the price the end-user is willing to pay the retailer and, (b) the retailer's target profit margin. No current business model enables the retailer or the wholesaler to eliminate this downside risk.

Waste time and energy: Currently any change in the supply of or the demand for X prompts price discussions between the originator and the wholesaler and between the wholesaler and the retailer. The time and energy spent on such discussions could be avoided. Unnecessary actions: Existing business models allow the purchaser to place one order covering many deliveries but there is currently no business model that makes it unnecessary for the buyer to place an order as a means of getting the goods he needs from a supplier. According to current business models, if a company needs X on a given day, a buyer has to remember to place an order in good time and spend time placing the order for X, if he wants to receive X. No control of work-flow: According to current business models, the buyer controls the timing of the order. This means the supplier must either sometimes delay supply to his customers or have premises, inventory, and a labor force all large enough to cope with peak workloads. In other words, the supplier cannot organize an even level of work over time and so ensure maximally efficient inventory management, use of his premises, and labor force.

### SUMMARY OF INVENTION

Risk reduction:

The present invention is a business model that requires (a) the prices paid by the end-user for a unit of X during a period to be used to determine the unit price paid for X by the retailer to the wholesaler and by the wholesaler to the originator (b) the retailer to agree to maximize his profits on the sale of X during the period.

This reduces both the downside risk and the upside gain for the retailer and wholesaler: this reduces the probability that the buyer (retailer or wholesaler) pays a price to his wholesaler that is either low or high relative to his target profit margin. This is a benefit to those businesses that want to reduce risk.

Save time and energy:

Also buyers (wholesalers and retailers) and sellers (originators and wholesalers) that use the current invention do not need to discuss prices at all. Instead they discuss what percentage of the retail price the wholesaler is to be paid and what percentage of the retail price the originator is to be paid for a consignment of X. Once this is agreed, the prices are calculated on the basis of the retail price. If the percentage remains stable, prices will fluctuate to reflect supply and demand without the need for any discussion.

No orders necessary:

The present invention is a business model according to which (a) a supplier (originator, wholesaler, or retailer) presents a document describing a suggested delivery of a specified quantity of X, to a buyer (wholesaler, retailer, or end-user)(b) on a date set by the supplier, this suggested delivery becomes a contract according to which the seller delivers the specified quantity of X to the buyer(c) the buyer may modify the suggested delivery before this agreed date(d) the buyer may turn the suggested delivery into a shopping list or simply cancel it before this agreed date.

When the future needs of a company can be predicted accurately on the basis of past usage, then the supplier can use this model, together with data on past usage and current inventory, to save the buyer the time and attention currently spent placing such routine orders.

Workflow control and reduced inventory:

According to the current invention the supplier determines the date on which he acquires the right to make a delivery of a specified quantity of X to the buyer. This means (a) the retailer determines the interval between delivery dates that is generally acceptable to the end-users (b) having determined this interval, the retailer, the wholesaler, and the originator are able to reduce their inventories to zero, if, during this interval the originator can manufacture, pick, pack and deliver the wholesaler can receive, pick, pack, and deliver the retailer can receive, pick, pack, and deliver.

(c) the sellers (originator, wholesaler, and retailer) can stagger the confirmed delivery dates, while preserving the delivery interval, to ensure that the amount of work is roughly the same each working day and in this way he can ensure maximally efficient use of his facilities and labor force.

Comment:

The objective price-setting is made practical by the Internet which can provide the retail prices for X to the wholesaler and the originator in real time and without human effort. The Internet also makes it practical for the supplier (originator, wholesaler, and retailer) to take the initiative by supplying him with access to the buyer (wholesaler, retailer, and end-user) inventory levels and to the end-user usage rates in real time and without human effort. In short the present invention exploits the benefits of the perfect information made possible by the Internet.

### BRIEF DESCRIPTION OF DRAWINGS

FIGS. 1, 2, and 3 are diagrams showing various aspects of the invention.

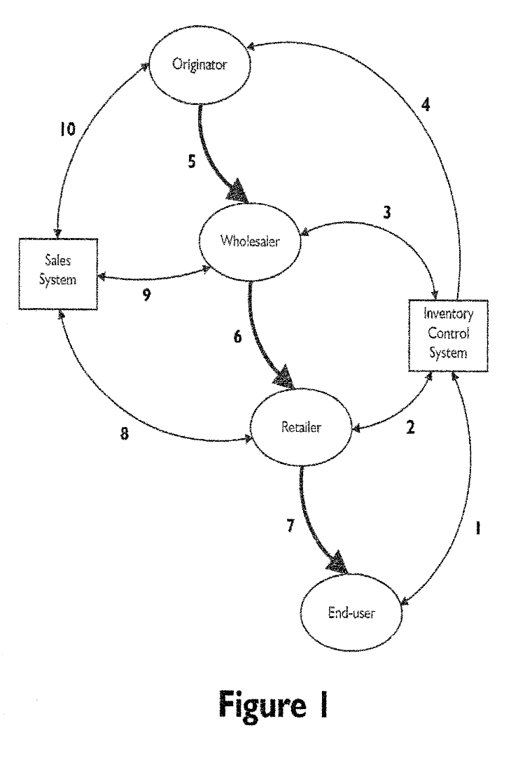

### DETAILED DESCRIPTION

One way of implementing The integrated Marketplace Model for product X is to create an Internet site where: (a) Originators, wholesalers, retailers, and end-users of X register as members of the marketplace for X (all references below to originators, wholesalers, retailers, and end-users are to these members).

(b) Each end-user of X indicates which retailers are to supply him with X and how his demand for X is to be split among these retailers; he also indicates his reserve inventory for X.

(c) Each retailer of X indicates which wholesalers are to supply him with X and how his demand for X is to be split among these wholesalers; he also indicates his reserve inventory for X.

(d) Each wholesaler of X indicates which originators are to supply him with X and how his demand for X is to be split among these originators; he also indicates his reserve inventory for X.

(e) Each end-user of X receives for each retailer assigned to him as described in (b) a proposed delivery for X based on 1. the latest end-user inventory for X; 2. the enduser's reserve inventory for X; 3. a forecast of the end-users' usage of X for a period, based on the end-user's past usage rates; 4. any rule described in (b) about how the end-user's demand is to be split among the retailers.

The end-user may modify or cancel the proposed delivery during an agreed period after receiving it. At the end of this period the proposed delivery becomes a confirmed delivery for X from the retailer to the end-user.

(f) Each retailer of X receives for each wholesaler assigned to him as described in (c) a proposed delivery for X based on 1. the latest retailer inventory for X; 2. the retailer's reserve inventory for X; 3. the confirmed deliveries for X received by the retailer for the end-users; 4. any rule described in (c) about how the retailer's demand is to be split among the wholesalers.

The retailer may modify or cancel the proposed delivery during an agreed period after receiving it. At the end of this period the proposed delivery becomes a confirmed delivery for X from the wholesaler to the retailer.

(g) Each wholesaler of X receives for each originator assigned to him as described in (d) a proposed delivery for X based on 1 the latest wholesaler inventory for X; 2. the wholesaler's reserve inventory for X; 3. the confirmed deliveries for X received by the wholesaler for the retailers; 4. any rule described in (d) about how the wholesaler's demand is to be split among the originators.

The wholesaler may modify or cancel the proposed delivery during an agreed period after receiving it. At the end of this period the proposed delivery becomes a confirmed delivery for X from the originator to the wholesaler.

(h) The retailers of X provide the retail prices for X and the quantities of X sold within the marketplace at each price, in real time.

(i) The wholesales of X provide the wholesale prices for X and quantities of X sold within the marketplace at each price, in real time.

(j) Each wholesaler of X charges each retailer he supplies with X a unit price that is an agreed percentage of the average retail price (referred to as the retail price percentage). This average is calculated using one of three types of retail average base: (i) the sales by this retailer, (ii) the sales by all retailers supplied by this wholesaler, (iii) the sales by all retailers. This average is calculated using a particular method, e.g. mean, median, mode (referred to as the average method).

(k) Each originator of X charges each wholesaler he supplies with X a unit price that is an agreed percentage of the average wholesale price (referred to as the wholesale price percentage). This average is calculated using one of three types of wholesale average base (i) the sales by this wholesaler, (ii) the sales by all wholesalers supplied by this originator, (iii) the sales by all wholesalers. This average is calculated using a particular method, e.g. mean, median, mode (referred to as the average method).

All this means: 1. The buyers (end-user, retailer, wholesaler) do not need to place orders the goods will arrive without being ordered, though the buyer will be able to cancel or modify the proposed delivery.

2. The end-users receive the goods that they need during the coming period.

3. The retailers receive the goods that they need to ensure the end-users have what they need.

4. The wholesalers receive the goods that they need to ensure the retailers have what they need.

5. Each retailer, wholesaler, and originator sets his delivery dates; this means:(i) he can stagger them to ensure even workflow (ii) together they can coordinate these dates, so as to ensure that a delivery interval agreed with the end-user is implemented.

6. A buyer (end-user, retailer, or wholesaler) can convert a proposed delivery of X into a shopping list; in this case he must choose a supplier (retailer, wholesaler, or originator) willing to accept orders and place an order with that supplier, if he wishes to receive X.

Description of Figure one

This figure describes an implementation of the current invention. The numbered arrows represent the flow of data or consignments of X as follows: Flow 1: Data supplied by an End-user to the Inventory Control System: (a) inventory levels of X in, deliveries of X to, and withdrawals of X from the End-user's store; (b) reserve inventory levels; (c) the Retailers from whom he wishes to buy X and how his demand is to be split among them; (d) amendments to proposed deliveries.

Data supplied by the Inventory Control System to an End-user. (e) details of proposed deliveries by Retailers selected as indicated by Flow 1 (c) above to the End-user of a quantity of X determined by reference to current and reserve inventory levels and forecasts of future usage of X during a specified period; this forecast is based on past usage trends for X by this End-user.

Flow 2: Data supplied by a Retailer to the Inventory Control System: (a) inventory levels of X in, deliveries of X to, and withdrawals of X from the Retailer's store; (b) reserve inventory levels; (c) the Wholesalers from whom he wishes to buy X and how his demand is to be split among them; (d) amendments to proposed deliveries.

Data supplied by the Inventory Control System to a Retailer: (e) details of each proposed delivery by the Retailer to an End-user selected as indicated by Flow 1 (c) above of a quantity of X determined by reference to current and reserve inventory levels, and forecasts of future usage of X during a specified period; this forecast is based on past usage trends for X by this End-user.

(f) details of proposed deliveries by Wholesalers selected as indicated by Flow 2 (c) above to the Retailer of a quantity of X determined by the Retailer's current set of unfulfilled confirmed deliveries to End-users and the Retailer's current and reserve inventory levels.

Flow 3: Data supplied by a Wholesaler to the Inventory Control System: (a) inventory levels of X in, deliveries of X to, and withdrawals of X from the Wholesaler's store; (b) reserve inventory levels; (c) the Originators from whom he wishes to buy X and how his demand is to be split among them; (d) amendments to proposed deliveries.

Data supplied by the Inventory Control System to a Wholesaler: (e) details of each proposed delivery by the Wholesaler to a Retailer selected as indicated by Flow 2 (c) above of a quantity of X determined by the Retailer's current set of unfulfilled confirmed deliveries to End-users and the Retailer's current and reserve inventory levels.

(f) details of proposed deliveries by Originators selected as indicated by Flow 3 (c) above to the Wholesaler of a quantity of X determined by the Wholesaler's current set of unfulfilled confirmed deliveries to Retailers and the Wholesaler's current and reserve inventory levels. Flow 4: Data supplied by the Inventory Control System to an Originator: (a) details of each proposed delivery by the Originator to a Wholesaler selected as indicated by Flow 3 (c) above of a quantity of X determined by the Wholesaler's current set of unfulfilled confirmed deliveries to Retailers, and the Wholesaler's current and reserve inventory levels.

Flow 5: Data and Goods supplied by the Originator to the Wholesaler: (a) delivery of a consignment of X from the Originator to the Wholesaler;(b) the unique delivery identifier within unique originator identifier.

Flow 6: Data and Goods supplied by the Wholesaler to the Retailer: (a) delivery of a consignment of X from the Wholesaler to the Retailer;(b) the unique delivery identifier within unique wholesaler identifier.

Flow 7: Data and Goods supplied by the Retailer to the End-user: (a) delivery of a consignment of X from the Retailer to the End-user;(b) the unique delivery identifier within unique retailer identifier.

Flow 8: Data supplied by a Retailer to the Sales System: (a) the prices paid by the End-users for X to the Retailer;(b) the quantities of X sold at each retail price by the Retailer; (c) the period P for which the average retail price is to be calculated for purposes of determining the wholesale price for X for that period charged by a given Wholesaler; (d) the agreement between the Retailer and this Wholesaler regarding the retail price percentage, the type of retail average base, and the average method for period P.

Data supplied by the Sales System to the Retailer: (e) for each Wholesaler that has an agreement as described in Flow 8 (d) with the Retailer for period P, the wholesale price for a unit quantity of X calculated as a product of the retail price percentage and the average retail price, where the average retail price is calculated according to this agreement.

Flow 9: Data supplied by a Wholesaler to the Sales System: (a) the period Q for which the average retail price is to be calculated for purposes of determining the originator price for X for that period charged by a given Originator; (b) the agreement between the Wholesaler and this Originator regarding the wholesale price percentage, the type of wholesale average base, and the average method for period Q; (c) confirmation of the data input by each Retailer about (i) the period P for which the average retail price is to be calculated see Flow 8 (c) above; (ii) the retail price percentage, the type of retail average base, and the average method agreed between the Wholesaler and that Retailer see Flow 8 (d) above

Data supplied by the Sales System to the Wholesaler. (d) for each Retailer that has an agreement as described in Flow 8 (d) with the Wholesaler for period P, the wholesale price for a unit quantity of X calculated as a product of the retail price percentage and the average retail price, where the average retail price is calculated according to this agreement.

(e) for each Originator that has an agreement as described in Flow 9 (b) with the Wholesaler for period Q, the originator price for a unit quantity of X calculated as a product of the wholesale price percentage and the average wholesale price, where the average wholesale price is calculated according to this agreement.

Flow 10: Data supplied by an Originator to the Sales System: (a) confirmation of the data input by each Wholesaler about (i) the period Q for which the average wholesale price is to be calculated see Flow 9 (a) above; (ii) the wholesale price percentage, the type of wholesale average base, and the average method agreed between the Originator and that Wholesaler—see Flow 9 (b) above.

Data supplied by the Sales System to the Originator. (b) for each Wholesaler that has an agreement as described in Flow 9 (b) with the Originator for period Q, the originator price for a unit quantity of X calculated as a product of the wholesale price percentage and the average wholesale price, where the average wholesale price is calculated according to this agreement.

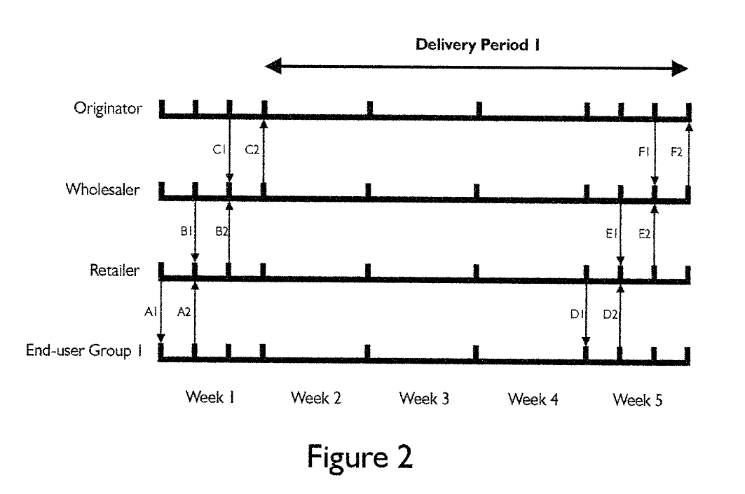

Description of FIG. 2

If the End-users have been divided into four groups, (each of which spends approximately the same amount with Retailers in the marketplace), this figure illustrates an example of how a marketplace adopting the present invention as its business model could organize its delivery decisions over time with respect to End-user Group 1.

(a) a proposed delivery A1 from a Retailer to a member of End-user Group 1 is presented at the beginning of Week 1; (b) during the first three days of Week 1 the End-user can cancel or amend the proposed delivery; after this, if it has not been cancelled, it becomes a confirmed delivery A2; (c) a proposed delivery B1 from a Wholesaler to a Retailer is presented at the end of the third day of Week 1; (d) during the fourth and fifth days of Week 1 the Retailer can cancel or amend the proposed delivery; after this, if it has not been cancelled, it becomes a confirmed delivery B2; (e) a proposed delivery C1 from an Originator to a Wholesaler is presented at the end of the fifth day of Week 1; (f) during the sixth and seventh days of Week 1 the Wholesaler can amend the proposed delivery; after this it becomes a confirmed delivery C2.

Similarly proposed deliveries, D1, E1, and F1, are presented during Week 5. If these are not cancelled by their respective deadlines, they become confirmed deliveries, D2, E2, and F2 respectively.

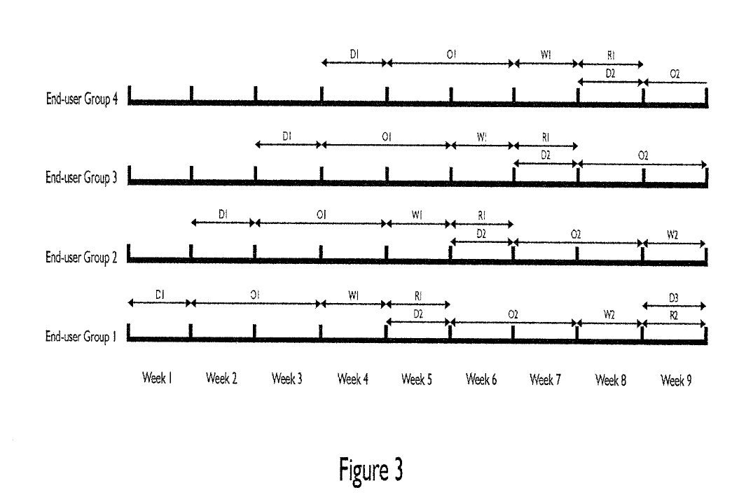

Description of FIG. 3

If the End-users have been divided into four groups, (each of which spends approximately the same amount with Retailers in the marketplace), this figure illustrates an example of how a marketplace adopting the present invention as its business model could organize its activities over a period of nine consecutive weeks:

For End-user Group 1 Delivery Cycle 1: (a) D1 Decision Period 1: The End-user, the Retailer, and the Wholesaler receive proposed deliveries and must decide what to do about them during Week 1. (b) O1 Originator Period 1: During Weeks 2 and 3 the Originator fulfills all the confirmed deliveries he has received from Wholesalers that indirectly supply these End-users. (c) W1 Wholesaler Period 1: During Week 4 the Wholesaler fulfills all the confirmed deliveries he has received from Retailers that supply these End-users.(d) R1 Retailer Period 1: During Week 5 the Retailer fulfills all the confirmed deliveries he has received from End-users. This completes the first Delivery Cycle for End-user 1.

For End-user Group 1 Delivery Cycle 2: (a) D2 Decision Period 2: During Week 5 the second cycle begins with the End-user, the Retailer, and the Wholesaler receiving proposed deliveries and deciding what to do about them.(b) O2 R2: During Weeks 6, 7, 8, and 9 the second cycle is completed in the same way as the first as described in Delivery Cycle 1 (b) (d).This completes the second Delivery Cycle for End-user 1.

For End-user Group 1 Delivery Cycle 3: (c) D3 Decision Period 3: During Week 9 the third cycle begins with the End-user, the Retailer, and the Wholesaler receiving proposed deliveries and deciding what to do about them. And so on.

For End-user Group 2 Delivery Cycles 1-3: (a) The cycles are exactly as for End-user Group 1, except that they start a week later on Day 1 of Week 2. For End-user Group 3 Delivery Cycles 1-3: (a) The cycles are exactly as for End-user Group 2, except that they start a week later on Day 1 of Week 3. For End-user Group 4 Delivery Cycles 1-3: (b) The cycles are exactly as for End-user Group 3, except that they start a week later on Day 1 of Week 4.

1. In a marketplace for a given product, that adopts The Integrated Marketplace Model a method comprising: each buyer selecting one or more default sellers and, if there is more than one such seller, indicating how his demand for this product for a given period, P, is to be split among these sellers.

2. The method of claim 1, further comprising each seller presenting any buyer that has selected him as a default seller with a proposed delivery of a specified quantity of this product.

3. The method of claim 2, further comprising a buyer altering or canceling each proposed delivery within an agreed period, Q, after its seller presents it.

4. The method of claim 3, further comprising, at the end of period Q each proposed delivery becoming a confirmed delivery unless the proposed delivery has been cancelled.

5. The method of claim 4, wherein, if a buyer is an end-user, a proposed delivery concerning a quantity of the product determined by reference to this buyer's current and reserve inventory, a forecast of future usage, and the buyer's wishes regarding what proportion of his demand for this product for the period P is to be assigned to the seller.

6. The method of claim 5, wherein if the buyer is not an end-user, a proposed delivery concerns a quantity of the product determined by reference to the buyer's current and reserve inventory, the unfulfilled confirmed deliveries received by the buyer, and the buyer's wishes regarding what proportion of his demand for this product for the period P is to be assigned to the seller.

7. In a marketplace for a given product, that adopts The Integrated Marketplace Model a method comprising: each wholesaler calculating the wholesale price per unit of that product during a given period, R, to each retailer as a percentage (agreed with that retailer) of the average retail price.

8. The method of claim 7, further comprising this wholesaler agreeing with this retailer the type of retail average base to be used and the average method to be used.

9. In a marketplace for a given product, that adopts The Integrated Marketplace Model a method comprising: each originator calculating the originator price per unit amount of that product during a given period, S, to each wholesaler as a percentage (agreed with that retailer) of the average wholesale price.

10. The method of claim 9, further comprising this originator agreeing with this wholesaler the type of wholesale average base to be used and the average method to be used.
